(19) United States
(12) Patent Application Publication
(10) Pub. No.: US 2022/0135084 A1
(43) Pub. Date: May 5, 2022

(54) VEHICLE AND SERVER TO COMMUNICATE WITH VEHICLE

(71) Applicants: Hyundai Motor Company, Seoul (KR); Kia Corporation, Seoul (KR)

(72) Inventor: Byung Il Choi, Seoul (KR)

(21) Appl. No.: 17/493,215

(22) Filed: Oct. 4, 2021

(30) Foreign Application Priority Data
Nov. 4, 2020 (KR) 10-2020-0146282

(51) Int. Cl. B60W 60/00; H04W 4/46; H04W 76/10; G06Q 10/08; G05D 1/00; B62D 53/00; G01C 21/34

(52) U.S. Cl. CPC B60W 60/00256; H04W 4/46; H04W 76/10; B60W 2556/50; G05D 1/0022; B62D 53/00; G01C 21/3407; G06Q 10/08355

(57) ABSTRACT

A server includes a communication device configured to communicate with a plurality of vehicles, a controller configured to receive location information of the vehicles, generate route information based on the received location information of the vehicles and goods transport information, transmit the generated route information to a first vehicle among the plurality of vehicles, select a second vehicle among the plurality of vehicles and a takeover location to take over goods based on delivery point information including a delivery point and location information of the vehicles when the delivery point information among the goods transport information is changed during traveling of the first vehicle, generate route information of the first and second vehicles based on waypoint information for the takeover location, and transmit the generated route information of the first and second vehicles to the first and second vehicles

### CROSS-REFERENCE TO RELATED APPLICATIONS

This application claims the benefit of Korean Patent Application No. 10-2020-0146282, filed on Nov. 4, 2020, which application is hereby incorporated herein by reference.

### TECHNICAL FIELD

The present disclosure relates to a vehicle and a server communicating with the vehicle.

### BACKGROUND

A vehicle represents a machine that travels by driving wheels for the purpose of transporting people or cargo, and moves on a road.

These vehicles can be divided into passenger vehicles used for personal use and movement, and commercial vehicles used for commercial use and transportation of goods or people, depending on the use.

Here, the commercial vehicles may include a truck that transports goods, a dump truck, a van, a forklift, and a special operation vehicle, and may include a bus and a taxi that transports people.

Such a vehicle may be connected to a trailer that is towed by the vehicle without having power at the rear of the vehicle and traveling on the road. This trailer can be designed for the purpose of transporting people or goods, or it can be designed to be detachably connected to the vehicle.

Types of trailers that can be connected to the passenger vehicle include caravans and mini-cargo trailers, and types of trailers that can be connected to trucks include full trailers, dollies, bus trailers, and semi-trailers.

Fuel economy of such a vehicle may vary depending on the weight of the vehicle, the number of occupants, or the amount of items loaded on the trailer.

### SUMMARY

The present disclosure relates to a vehicle and a server communicating with the vehicle. Particular embodiments relate to a vehicle and a server communicating with the vehicle for improving stability of autonomous driving.

Therefore, an embodiment of the present disclosure provides a vehicle that controls to autonomously drive up to take over information to take over a trailer loaded with goods to another vehicle when a destination is changed during autonomous driving, and a server communicating with the vehicle.

In accordance with one embodiment of the present disclosure, there is provided a server including a communication device configured to communicate with a plurality of vehicles, and a controller configured to receive location information of the plurality of vehicles, generate route information based on the received location information of the plurality of vehicles and goods transport information, transmit the generated route information to a first vehicle among the plurality of vehicles, select a second vehicle and a takeover location to take over the goods based on delivery point information and location information of the plurality of vehicles when the delivery point information among the goods transport information is changed during traveling of the first vehicle, generate route information of the first and second vehicles based on waypoint information for the takeover location, and transmit the generated route information of the first and second vehicles to the first and second vehicles, respectively.

The controller of the server may generate an authentication number and transmit the generated authentication number to the first and second vehicles.

In response to location information of the first vehicle and the location information of the second vehicle being received, the controller of the server may acquire distance information on a distance between the first and second vehicles based on the received location information of the first vehicle and the received location information of the second vehicle, determine whether the first and second vehicles are adjacent to each other based on the acquired distance information, and transmit adjacency information of the first and second vehicles to the first and second vehicles.

The controller of the server may select the takeover information based on a full width, full length and total height of a trailer provided in the first vehicle, and a full width, full length and total height of a trailer provided in the second vehicle.

The controller of the server may determine whether to take over the article based on fuel amount of the first vehicle, weight of the goods, distance between the first vehicle and the delivery point, and distance between the second vehicle and the delivery point.

The controller of the server may transmit identification information of the second vehicle to the first vehicle, and transmit identification information of the first vehicle to the second vehicle.

In response to the location information of the first vehicle and the location information of the second vehicle being received, the controller of the server may acquire distance information on the distance between the first and second vehicles based on the received location information of the first vehicle and the location information of the second vehicle, and transmit the acquired distance information to the first and second vehicles.

In accordance with one embodiment of the present disclosure, there is provided a vehicle including a tractor, a trailer detachably coupled to the tractor and loaded with goods, a coupling member configured to couple and detach the trailer, a communication device configured to communicate with the server and another vehicle and receive location information, and a controller configured to, in response to first route information being received from the server, control autonomous driving based on the received first route information, in response to a takeover command, waypoint information and second route information being received from the server, control autonomous driving based on the received second route information, and control an operation of the coupling member to detach the trailer based on the received location information and waypoint information.

The controller of the vehicle according to the other embodiment may transmit a separation signal of the trailer to the server in response to determining that a separation of the trailer is successful.

The controller of the vehicle according to the other embodiment may receive and store an authentication number from the server, attempt a communication connection with the other vehicle in response to determining that current information is a waypoint based on the received location information and waypoint information, receive an authentication number of the other vehicle in response to communication with the other vehicle being connected, and determine whether the other vehicle is a vehicle to take over the trailer based on whether the stored authentication number and the received authentication number match.

The controller of the vehicle according to the other embodiment may delete the stored authentication number in response to determining that the separation of the trailer is successful.

The controller of the vehicle according to the other embodiment may acquire distance information on a distance to the other vehicle in response to communication with the other vehicle being connected.

The controller of the vehicle according to the other embodiment may further include an image acquisition device, and the controller is configured to store identification information of the other vehicle received from the server, acquire identification information of the other vehicle based on image information acquired by the image acquisition device and determine whether the other vehicle is a vehicle to take over the trailer based on whether the acquired identification information of the other vehicle matches the stored identification information of the other vehicle.

The controller of the vehicle according to the other embodiment may receive and store an authentication number from the server, attempt a communication connection with the other vehicle in response to determining that current information is a waypoint based on the received location information and waypoint information, transmit an authentication number of the other vehicle in response to communication with the other vehicle being connected, and control the operation of the coupling member so that the trailer is detached in response to matching information of the authentication number being received from the other vehicle.

In accordance with one embodiment of the present disclosure, there is provided a vehicle including a tractor configured to connect and disconnect a trailer, a coupling member configured to engage and disengage the trailer, a communication device configured to communicate with the server and other vehicles and receive location information, and a controller configured to control autonomous driving based on a takeover command from the server, waypoint information, and route information based on the received route information, in response to a takeover command, waypoint information and route information being received from the server, control autonomous driving based on the received route information, and control an operation of the coupling member so that the trailer is coupled to the tractor based on the received location information and waypoint information.

The controller of the vehicle according to the other embodiment may transmit a separation signal of the trailer to the server in response to determining that a coupling of the trailer is successful.

The controller of the vehicle according to the other embodiment may receive and store an authentication number from the server, attempt a communication connection with the other vehicle in response to determining that current information is a waypoint based on the received location information and waypoint information, receive an authentication number of the other vehicle in response to communication with the other vehicle being connected, and determine whether the other vehicle is a vehicle to take over the trailer based on whether the stored authentication number and the received authentication number match.

The controller of the vehicle according to the other embodiment may delete the stored authentication number in response to determining that the coupling of the trailer is successful.

The controller of the vehicle according to the other embodiment may acquire distance information about a distance to the other vehicle in response to communication with the other vehicle being connected, transmit the acquired distance information to the server, and control the operation of the coupling member so that the trailer is coupled in response to adjacency information being received from the server.

The controller of the vehicle according to the other embodiment may further include an image acquisition device, and the controller may store identification information of the other vehicle received from the server, acquire identification information of the other vehicle based on image information acquired by the image acquisition device, and determine whether the other vehicle is a vehicle to take over the trailer based on whether the acquired identification information of the other vehicle matches the stored identification information of the other vehicle.

### BRIEF DESCRIPTION OF THE DRAWINGS

These and/or other embodiments of the disclosure will become apparent and more readily appreciated from the following description of exemplary embodiments, taken in conjunction with the accompanying drawings, in which:

FIG. 1 is a configuration diagram of an autonomous driving system including a vehicle according to an embodiment;

FIG. 2 is an exemplary view of an exterior of a vehicle according to an embodiment;

FIG. 3 is an exemplary view of a recognition area of a vehicle shown in FIG. 2;

FIG. 4 is a control configuration diagram of a vehicle according to an embodiment;

FIG. 5 is a detailed configuration diagram of a controller of a vehicle according to an embodiment;

FIG. 6 is a control configuration diagram of a server communicating with a vehicle according to an embodiment;

FIG. 7 is a detailed configuration diagram of a controller of a server communicating with a vehicle according to an embodiment;

FIG. 8 is a detailed configuration diagram of a controller of a server communicating with a vehicle according to an embodiment;

FIG. 9 is a control flowchart of a server communicating with a vehicle according to an embodiment; and

FIG. 10 is a control flowchart of a vehicle according to an embodiment.

### DETAILED DESCRIPTION OF ILLUSTRATIVE EMBODIMENTS

Like numerals refer to like elements throughout the specification. Not all elements of embodiments of the present disclosure will be described, and description of what are commonly known in the art or what overlap each other in the embodiments will be omitted.

The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and embodiments of the present disclosure will be described with reference to the accompanying drawings.

First, depending on a purpose, a vehicle may be divided into a passenger vehicle used for personal use and movement, and a commercial vehicle used for commercial purposes and transport of goods or people.

Here, the commercial vehicle may include a truck, a dump truck, a van, a forklift, and a special work vehicle for transporting goods, and may include a bus and a taxi for transporting people.

A trailer that is towed by a vehicle and travels on the road without power may be connected to the rear of the vehicle.

This trailer may be designed for the purpose of transporting people or goods, and may be designed to be detachably connected to the vehicle.

Types of trailers that may be connected to passenger cars include caravans and mini-cargo trailers, and types of trailers that may be connected to trucks include full trailers, dollies, bus trailers, and semi-trailers.

The vehicle of this embodiment is a vehicle having an autonomous driving function, and may include an autonomous driving control apparatus. The vehicle having such an autonomous driving function may include various devices for detecting and recognizing obstacles around the vehicle for autonomous driving. The number and installation locations of these various devices may be different depending on the type or size of the vehicle, and a recognition area for recognizing an obstacle may be different from each other.

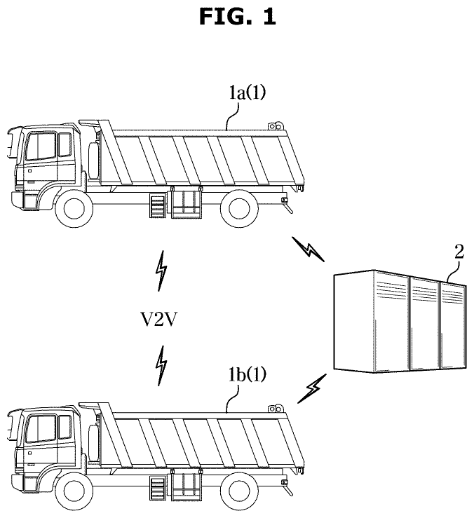

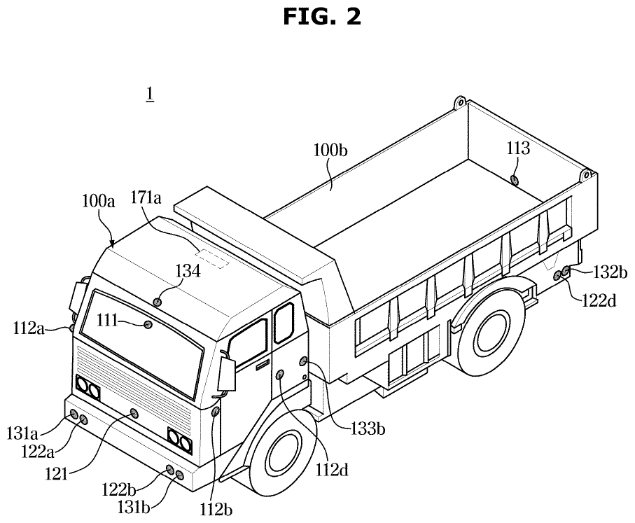

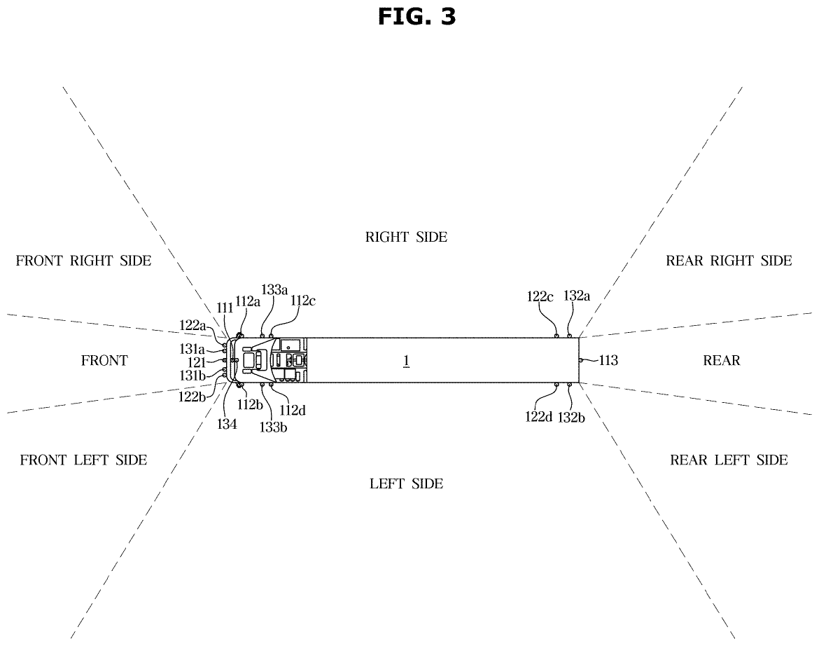

FIG. 1 is a configuration diagram of an autonomous driving system including a vehicle according to an embodiment, FIG. 2 is an exemplary view of an exterior of a vehicle according to an embodiment, and FIG. 3 is an exemplary view of a recognition area of a vehicle shown in FIG. 2.

As shown in FIG. 1, a first vehicle 1a may perform vehicle-to-vehicle communication (V2V) with a second vehicle 1b corresponding to another vehicle. Here, the first and second vehicles 1a and 1b may be trucks for transporting goods. The first and second vehicles 1a and 1b communicate with a server 2, receive route information to a destination, and control autonomous driving from a departure point to the destination based on the received route information.

As shown in FIG. 2, the vehicle 1: 1a, 1b may include a tractor 100a having a driving force, and a trailer 100b detachably connected to the tractor 100a and loaded with cargo. Here, the trailer 100b may be automatically detached from the tractor 100a and connected automatically.

The configurations of the first and second vehicles 1a and 1b are identical to each other. Accordingly, the configuration of the first vehicle 1a and the second vehicle 1b will be described by integrating the configuration of the vehicle 1.

The vehicle 1 tows the tractor 100a and the trailer 100b, and includes a body with interior and exterior, and a chassis on which mechanical devices necessary for driving are installed with a rest except for the body.

The exterior of the body includes a hood, front left and right doors, window glass, and a west coast mirror that provides a driver with field of view in the rear of the vehicle 1.

The trailer 100b may be loaded with various types of cargo. At this time, the cargo loaded on the trailer 100b may include people as well as goods.

The trailer 100b is moved by a power source of the tractor 100a, and as a result, it may be possible to transport the cargo loaded on the trailer 100b.

The interior of the vehicle 1 may include a seat on which an occupant sits, a dashboard, an instrument panel (that is, a cluster), a center fascia, a head unit, an input device, and a display.

The vehicle 1 includes an accelerator pedal pressed by a user according to acceleration intention of the user, a brake pedal pressed by the user according to braking intention of the user, and a steering wheel of a steering device for adjusting a traveling direction.

In addition, in response to the vehicle being a vehicle capable of autonomous driving without the driver, the accelerator pedal, the brake pedal, the steering wheel, the input device, and the display may be omitted.

The chassis of the vehicle 1 further includes a driving device for applying driving force and braking force to the front and rear left and right wheels, such as a power generating device, a power transmitting device, a steering device, a braking device, a suspension device, a transmission device, and the like.

The vehicle 1 includes an image acquisition device 110 for securing a field of view facing the front, left and right sides and rear of the vehicle 1, and first and second distance detectors 120 and 130 that are provided on the front, rear, left and right sides of the exterior of the vehicle, and detect an obstacle existing in a recognition area of an obstacle such as a front, left, right, and rear, and recognizing a distance from the detected obstacle.

The image acquisition device 110 may include a front camera 111, a plurality of side cameras 112 and a rear camera 113.

The front camera 111 may be installed on a front windshield glass of the vehicle.

The front camera 111 may capture the front of the vehicle and acquire image data in front of the vehicle.

The image data in front of the vehicle may include location information about at least one of other vehicles, pedestrians, cyclists, lanes, curbs, guard rails, street trees, and street lights located in front of the vehicle.

A plurality of side cameras 112: 112a, 112b, 112c, 112d are provided on one side of the door on the left side and the right side of the tractor 100a, and include first and second side cameras in which a capturing direction faces forward, and third and fourth side cameras in which a capturing direction faces rearward.

The first and second side cameras 112a, 112b may capture the left and right side directions of the vehicle 1, and the third and fourth side cameras 112c and 112d may capture the left and right rear directions of the vehicle and may acquire left and right image data in front of the vehicle and left and right image data in the rear of the vehicle. The left and right image data in front of the vehicle and the image data in front of the vehicle may include location information about at least one of other vehicles, pedestrians, cyclists, lanes, curbs, guard rails, street trees, and street lights located in the left and right directions in front of the vehicle and in the left and right directions behind the vehicle.

The rear camera 113 may be installed on the rear of the trailer of the vehicle.

The rear camera 113 may capture the rear of the vehicle and acquire image data of the rear of the vehicle. The image data at the rear of the vehicle may include location information about at least one of other vehicles, pedestrians, cyclists, lanes, curbs, guard rails, street trees, and street lights located at the rear of the vehicle.

Each camera of the image acquisition device 110 may include a plurality of lenses and an image sensor, respectively. The image sensor may include a plurality of photodiodes that convert light into an electrical signal, and the plurality of photodiodes may be arranged in a two-dimensional matrix.

Each camera may transmit image data in each direction to a first controller 172. The first and second distance detectors 120 and 130 are devices having different obstacle detection methods, the first distance detector 120 may include a radio detecting and ranging (radar) device, and the second distance detector 130 may include a light detection and ranging (lidar) device.

The radar may include a transmission antenna (or a transmission antenna array) that radiates a transmission wave and a reception antenna (or a reception antenna array) that receives a reflected wave reflected by an obstacle.

Such a radar is a device that detects a location of the obstacle by using a reflected wave generated by the radiation of radio waves in response to transmission and reception being performed in the same place.

The radar uses a Doppler effect to prevent the transmitted and received radio waves from overlapping and being difficult to distinguish, or changes the frequency of the transmit radio wave over time, or outputs a pulse wave as the transmit radio wave.

The lidar is a non-contact distance detection sensor using a principle of laser radar.

The lidar may include a transmitter that transmits a laser and a receiver that receives the laser reflected back from the surface of an obstacle existing in a field of sensing.

Since lidar has higher detection accuracy in the lateral direction than the radar, the accuracy of the process of determining whether a passage exists in front may be improved.

The first distance detector 120 may include a front radar 121 and a plurality of corner radars 122. The forward radar 121 may have a field of sensing facing forward of the vehicle 1 and may detect an obstacle existing in the sensing field corresponding to this field of sensing.

The front radar 121 may be installed in front of the tractor 100a.

The front radar 121 may acquire front radar data from the transmitted wave transmitted by the transmission antenna and the reflected wave received by the reception antenna.

The front radar data may include location information and speed information about other vehicles or pedestrians or cyclists located in front of the vehicle.

The forward radar 121 may calculate a relative distance to an obstacle based on a phase difference (or time difference) between the transmitted wave and the reflected wave, and calculate a relative speed of an obstacle based on a frequency difference between the transmitted wave and the reflected wave.

The plurality of corner radars 122 may include a first corner radar 122a installed on the front right side of the vehicle, a second corner radar 122b installed on the front left side of the vehicle, a third corner radar 122c installed on the rear right side of the vehicle, and a fourth corner radar 122d installed on the rear left side of the vehicle.

The first corner radar 122a may have a field of sensing facing the front right side of the vehicle, and may detect an obstacle existing in a sensing area corresponding to this field of sensing, and may be installed on the right side of the front of the tractor 100a.

The second corner radar 122b may have a field of sensing facing the front left of the vehicle, and may detect an obstacle existing in a recognition area corresponding to this field of sensing, and may be installed on the left side of the front of the tractor 100a.

The third corner radar 122c may have a field of sensing facing the rear right of the vehicle, and may detect an obstacle existing in a recognition area corresponding to this field of sensing, and may be installed on the right side of the rear of the trailer 100b.

The fourth corner radar 122d may have a field of sensing facing the rear left of the vehicle, and may detect an obstacle existing in a recognition area corresponding to this field of sensing, and may be installed on the left side of the rear of the trailer 100b.

The first, second, third and fourth corner radars 122a, 122b, 122c, and 122d may acquire first corner radar data, second corner radar data, third corner radar data, and fourth corner radar data, respectively.

The first corner radar data may include distance information and speed information about another vehicle, a pedestrian or a cyclist (hereinafter, referred to as “an obstacle”) located on the front right side of the vehicle 1.

The second corner radar data may include distance information and velocity information about an obstacle located on the front left side of the vehicle 1.

The third and fourth corner radar data may respectively include distance and velocity information of an obstacle located on the rear right side and the rear left side of the vehicle 1.

Each of the first, second, third, and fourth corner radars 122a, 122b, 122c, and 122d may be connected to the first controller 172 through a vehicle communication network NT, a hard wire, or a printed circuit board. The first, second, third, and fourth corner radars 122a, 122b, 122c, and 122d may respectively transmit the first corner radar data, the second corner radar data, the third corner radar data, and the fourth corner radar data to the controller. Here, the first controller 172 may be a controller provided in the vehicle 1 or a controller of an autonomous driving control apparatus 170.

The second distance detector 130 may include first and second front lidar 131a, 131b, first and second rear lidar 132a, 132b, and first and second side lidar 133a, 133b, and may further include a third front lidar 134.

Here, the third front lidar 134 may be a high-resolution lidar having a higher resolution than that of the first and second front lidar 131a, 131b, the first and second rear lidar 132a, 132b, and the first and second side lidar 133a, 133b.

In the case of the direct pulse method, the lidar measures the time of the laser reflected back from the obstacle after transmitting a single pulsed laser, and acquires distance information about the relative distance to the obstacle.

In the case of the continuous wave method, the lidar measures the amount of phase change of the laser signal reflected back from the obstacle after transmitting a continuously modulated laser with a specific frequency, and acquires distance information about time and relative distance to obstacles.

The first front lidar 131a may have a field of sensing directed toward a front and right of the vehicle 1, and may detect an obstacle existing in a sensing area corresponding to the field of sensing.

The front radar 131a may be installed in the front right side of the tractor 100a.

The front radar 131a may acquire laser data in a front right direction from the transmitted wave transmitted by the transmitter and the reflected wave received by the receiver.

The laser data in the front right direction may include distance information about an obstacle located in the front and right directions of the vehicle, and further may include speed information.

The second front lidar 131b may have a field of sensing directed toward a front and left of the vehicle 1, and may detect an obstacle existing in a sensing area corresponding to the field of sensing.

The second front lidar 131b may be installed on the front left side of the tractor 100a.

The second front lidar 131b may acquire laser data in a front left direction from the transmitted wave transmitted by the transmitter and the reflected wave received by the receiver.

The laser data in the front left direction may include distance information about an obstacle located in the front and left directions of the vehicle, and further may include speed information.

The first rear lidar 132a may have a field of sensing directed toward a rear and the right side of the vehicle 1, and may detect an obstacle existing in a sensing area corresponding to the field of sensing.

The first rear lidar 132a may be installed on a rear right side of the trailer 100b.

The first rear lidar 132a may acquire laser data in a rear right direction from the transmitted wave transmitted by the transmitter and the reflected wave received by the receiver.

The laser data in the rear right direction may include distance information about an obstacle located in the rear and right directions of the vehicle, and further may include speed information.

The second rear lidar 132b may have a field of sensing directed toward a rear and left of the vehicle 1, and may detect an obstacle existing in a sensing area corresponding to the field of sensing.

The second rear lidar 132b may be installed on the rear left side of the trailer 100b.

The second rear lidar 132b may acquire laser data in a rear left direction from the transmitted wave transmitted by the transmitter and the reflected wave received by the receiver.

The laser data in the rear left direction may include distance information about an obstacle located in the rear and left directions of the vehicle, and further may include speed information.

The first side lidar 133a may have a field of sensing directed facing a right direction of the vehicle 1, and may detect an obstacle existing in a sensing area corresponding to the field of sensing.

The first side lidar 133a may be installed on the right side of the tractor 100a.

The first side lidar 133a may acquire laser data in the right direction from the transmitted wave transmitted by the transmitter and the reflected wave received by the receiver.

The laser data in the right direction may include distance information about an obstacle located in the right direction of the vehicle, and further may include speed information.

The second side lidar 133b may have a field of sensing facing a left direction of the vehicle 1 and may detect an obstacle existing in a sensing area corresponding to the field of sensing.

The second side lidar 133b may be installed on the left side of the tractor 100a. Here, the side of the tractor may be located adjacent to the door.

The second side lidar 133b may acquire laser data in the left direction from the transmitted wave transmitted by the transmitter and the reflected wave received by the receiver.

The laser data in the left direction may include distance information about an obstacle located in the left direction of the vehicle, and further may include speed information.

The third front lidar 134 may have a field of sensing facing the front of the vehicle 1, and may detect an obstacle existing in a sensing area corresponding to this field of sensing.

The field of sensing of the third front lidar 134 may be narrower than the field of sensing of the front radar.

That is, the front distance that may be detected by the third front lidar 134 may be shorter than the front distance that may be detected by the front radar.

The third front lidar 134 may be installed on a roof panel of the tractor low or above the front windshield glass.

The third front lidar 134 may acquire front laser data from the transmitted wave transmitted by the transmitter and the reflected wave received by the receiver.

The front laser data may include distance information about an obstacle located in front of the vehicle, and further may include speed information.

As shown in FIG. 3, the vehicle 1 recognizes an obstacle existing in front of the vehicle 1 using at least one of the front radar 121, the front camera 111 and the third front lidar 134. Here, recognizing the obstacle may include acquiring obstacle information.

Here, the front radar 121 recognizes a long-distance obstacle in the front of the vehicle, and the front camera 111 and the third front lidar 134 recognize a short-distance obstacle in the front of the vehicle.

That is, the front radar 121 may recognize an obstacle existing in front of the vehicle, but may recognize an obstacle that exists at a greater distance than the front camera 111 and the third front lidar 134.

Here, the front of the vehicle may be a center of an advancing direction of the vehicle based on the traveling direction of the vehicle.

The vehicle 1 recognizes an obstacle existing in the front right direction (i.e. front right side) of the vehicle using at least one of the first front lidar 131a, the first side camera 112a, and the first corner radar 122a.

The vehicle 1 recognizes an obstacle existing in the front left direction (i.e. front left side) of the vehicle using at least one of the second front lidar 131b, the second side camera 112b, and the second corner radar 122b.

The vehicle 1 recognizes an obstacle existing in the right direction (i.e. right side) of the vehicle using at least one of the third side camera 112c and the first side lidar 133a.

The vehicle 1 recognizes an obstacle existing in the left direction (i.e. left side) of the vehicle using at least one of the fourth side camera 112d and the second side lidar 133b.

The vehicle 1 recognizes an obstacle existing in the rear right direction (i.e. rear right side) of the vehicle using at least one of the third corner radar 122c and the first rear lidar 132a.

The vehicle 1 recognizes an obstacle existing in the rear left direction (i.e. rear left side) of the vehicle using at least one of the fourth corner radar 122d and the second rear lidar 132b.

The vehicle 1 recognizes an obstacle existing in the rear of the vehicle using at least one of the third corner radar 122c, the fourth corner radar 122d, and the rear camera 113.

The rear camera 113 recognizes a short-distance obstacle existing in the rear of the vehicle, and the third corner radar 122c and the fourth corner radar 122d recognize a long-distance obstacle existing in the rear of the vehicle.

That is, the third corner radar 122c and the fourth corner radar 122d may recognize an obstacle existing in the rear of the vehicle, but recognize an obstacle existing at a greater distance than the rear camera 113.

Here, the front, front left, front right, left, right, rear right, rear left and rear are movable areas in which the vehicle 1 may move in response to the obstacle information recognized by each device.

When recognizing obstacles in each movable area while controlling autonomous driving, devices used for obstacle recognition are determined for each movable area, and this is stored in the vehicle as device information for recognizing obstacles in each movable area of the vehicle.

The vehicle may further include an ultrasonic sensor as the first and second distance detectors.

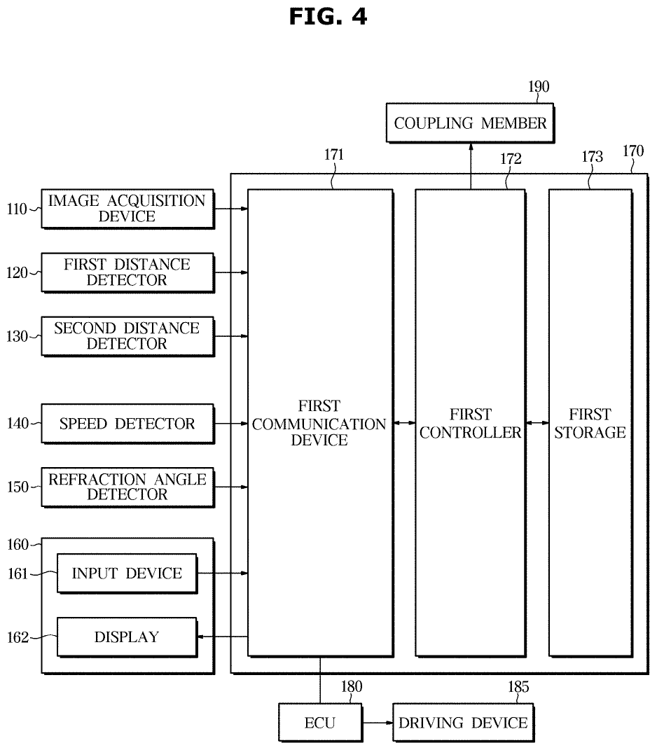

FIG. 4 is a control configuration diagram of a vehicle according to an embodiment.

The control configuration of the first and second vehicles 1a and 1b may be the same as each other. Accordingly, the description will be based on the first vehicle 1a, and the vehicle that communicates with the first vehicle and hands over the goods will be described as the second vehicle 1b.

The first vehicle 1a includes the image acquisition device 110, the first distance detector 120, the second distance detector 130, a speed detector 140, a refraction angle detector 150, a terminal 160, an autonomous driving control apparatus 170, an Electronic Control Unit (ECU) 180, and a driving device 185.

The image acquisition device 110, the first distance detector 120, and the second distance detector 130 are omitted from the description of the control configuration of the first vehicle 1a as already described with reference to FIGS. 2 and 3.

The speed detector 140 detects traveling speed of the first vehicle 1a and transmits speed information on the detected traveling speed to the autonomous driving control apparatus 170.

The speed detector 140 includes a plurality of wheel speed sensors that output detection information (i.e. wheel speed information) corresponding to rotational speed of wheels provided on the front, rear, left, and right wheels 131 of the first vehicle 1a.

The speed detector 140 may also include an acceleration sensor that outputs detection information (i.e. acceleration information) corresponding to acceleration of the first vehicle 1a.

The speed detector 140 may also include both the plurality of wheel speed sensors and the acceleration sensor.

The refraction angle detector 150 may detect an angle between the tractor and the trailer and transmit the angle for the detected angle to the first controller 172.

The terminal 160 displays information about a function operating in the first vehicle 1a or a function operable in the vehicle, and also displays information input by the user.

In response to at least one of navigation mode, broadcast mode, audio mode, video mode, phone call mode, radio mode and Internet mode being selected, for example, the terminal 160 may perform a function for at least one selected mode and display operation information of the function being performed, and may, in response to the autonomous driving mode being selected, display map information in which a route is matched and display images of front and rear left and right of the first vehicle 1a.

The terminal 160 may include a display 162 and may also further include an input device 161.

In response to both the display 162 and the input device 161 being provided in the terminal 160, the terminal 160 may be a touch screen in which the input device 161 and the display 162 are integrally provided.

In response to only the display being provided in the terminal, the input device may be provided on the head unit or the center fascia of the first vehicle 1a, and may be provided as at least one of a button, a switch, a key, a touch panel, a jog dial, a pedal, a keyboard, a mouse, a track-ball, various levers, a handle or a stick.

In this embodiment, the terminal 160 in which the input device 161 and the display 162 are integrally provided will be described.

The input device 161 of the terminal 160 receives an autonomous driving command, a departure command, and an operation command of a navigation mode, and receives destination information about a destination when the navigation mode is performed.

The input device 161 may also receive selection information of any one of a plurality of routes searched from the departure point to the destination, or from the current information to the destination.

The input device 161 may also receive waypoint information for takeover information for takeover of the goods.

The display 162 displays a route to a destination and a map in which the route is matched when the autonomous driving and navigation modes are performed.

The display 162 may display a route corresponding to a change in destination and a map in which the route is matched.

The display 162 may display information on a change in fuel efficiency and a change in goods delivery time according to the takeover of the goods.

The display 162 may also be configured to display waypoint information for takeover information, and also display a route corresponding to waypoint information.

The autonomous driving control apparatus 170 automatically controls a driving of the first vehicle 1a to the destination by automatically recognizing the road environment of the first vehicle 1a, determining a driving situation, and controlling the driving of the first vehicle 1a according to the planned driving route.

This autonomous driving control apparatus 170 controls the driving of the first vehicle 1a while recognizing obstacles and lanes in an autonomous driving mode and avoiding obstacles based on information on the recognized obstacles and lanes.

The autonomous driving control apparatus 170 includes a first communication device 171, the first controller 172, and a first storage 173.

The first communication device 171 allows communication to be performed between various devices provided in the first vehicle 1a.

The first communication device 171 performs CAN communication, USB communication, Wi-Fi communication, and Bluetooth communication, and further performs broadcasting communication such as TPEG, SXM, and RDS such as DMB, and 2G, 3G, 4G and 5G communication.

The first communication device 171 may include one or more components enabling communication with an external device, and for example, may include at least one of a short-range communication module, a wired communication module, and a wireless communication module.

Here, the external device may be the server 2 that manages and controls autonomous driving.

The short-range communication module may include various short-range communication modules that transmit and receive signals using a wireless communication network in a short range, such as a Bluetooth module, an infrared communication module, a radio frequency identification (RFID) communication module, a wireless local access network (WLAN) communication module, a NFC communication module, and a Zigbee communication module.

The wired communication module may include various wired communication modules, such as a controller area network (CAN) communication module, a local area network (LAN) module, a wide area network (WAN) module, or a value added network communication (VAN) module, and various cable communication modules, such as a universal serial bus (USB) module, a high definition multimedia interface (HDMI) module, a digital visual interface (DVI) module, a recommended standard-232 (RS-232) module, a power line communication module, or a plain old telephone service (POTS) module.

The wireless communication module may include wireless communication modules supporting various wireless communication methods, such as a WiFi module, a wireless broadband (WiBro) module, a global system for mobile communication (GSM) module, a code division multiple access (CDMA) module, a wideband code division multiple access (WCDMA) module, a universal mobile telecommunications system (UMTS) module, a time division multiple access (TDMA) module, a long term evolution (LTE) module, and the like.

The first communication device 171 may include a location receiver.

The first communication device 171 includes a GPS receiver which is a location receiver that communicates with a plurality of satellites and recognizes current information based on information provided from the plurality of satellites.

That is, the GPS receiver recognizes the current information of the vehicle by receiving the signal sent by the artificial satellite, and transmits current location information for the recognized current information to the first controller 172.

The location receiver may include at least one of GNSS, GLONASS, GALILEO, and BEIDOU in addition to GPS.

The first controller 172 may recognize the current location information at a time when the engine is turned off and transmit the recognized current location information to the server 2.

The first controller 172 may recognize the current location information in response to the request of the server 2 and transmit the recognized current location information to the server 2.

When identification information of the trailer is received from server 2, the first controller 172 acquires location information of the trailer based on the identification information of the trailer and controls autonomous driving based on the acquired location information of the trailer, and searches for a trailer with the acquired identification information of the trailer based on the image information acquired by the image acquisition device 110, and controls automatic coupling with the trailer when the trailer with the acquired identification information of the trailer is searched.

When it is determined that the trailer is automatically coupled, the first controller 172 controls autonomous driving to the destination based on the route information received from the server 2. When a start command is received, the first controller 172 may control the driving device 185 to control autonomous driving.

The departure command may be received through the server 2 or the first input device 161.

When a goods load completion command is received through the input device while the trailer is connected to the tractor of the vehicle by the driver, the first controller 172 may also control autonomous driving to a destination based on the route information received from the server 2.

The first controller 172 may control steering, braking, deceleration, and acceleration based on image information of the image acquisition device 110 during autonomous driving control, distance information with obstacles of the first and second distance detectors 120 and 130, traveling speed information of the speed detector 140, refraction angle information of the refraction angle detector 150 and current location information of the location receiver.

When an image is received from the image acquisition device 110 while the autonomous driving mode is being performed, the first controller 172 may perform image processing on the received image to recognize a lane of a road, recognize a lane based on location information of the recognized lane, and control autonomous driving along the recognized lane.

The first controller 172 may recognize at least one of the location of the obstacle and the moving speed of the obstacle based on the obstacle information detected by the image acquisition device 110 and the first and second distance detectors 120 and 130 during autonomous driving control, may determine the movable area based on the recognized location of the obstacle, may also control the movement to the determined movable area and may also control the traveling speed based on the recognized location of the obstacle and the moving speed of the obstacle.

The location of the obstacle may include the direction of the obstacle relative to the vehicle 1a and the distance from the obstacle. The first controller 172 may acquire the traveling speed of the vehicle 1a based on the detection information output from the plurality of wheel speed sensors.

The first controller 172 may also obtain the traveling speed of the vehicle 1a based on the detection information output from the acceleration sensor.

The first controller 172 may also obtain the traveling speed of the vehicle 1a based on the detection information output from the plurality of wheel speed sensors and the detection information output from the acceleration sensor.

The first controller 172 may also acquire the traveling speed based on change information of the current location information provided from the location receiver.

The first controller 172 is also capable of receiving route information from the server 2 after transmitting transport information of the trailer to the server 2.

Here, the transport information of the trailer may include information on a destination, a delivery date, and time corresponding to the goods delivery point.

When the route information is received, the first controller 172 may control the display 162 to match the received route information to map information and display it as an image.

When destination information and transport information for a destination are received through the first input device 161, the first controller 172 may also transmit the received destination information to the server 2.

That is, after transmitting the current location information to the server 2, the first controller 172 may control autonomous driving based on the identification information of the trailer, destination information, route information, and transport information received from the server 2.

The first controller 172 may transmit the destination information and transport information input to the input device 161 to the server 2, and then control autonomous driving based on the route information transmitted from the server 2.

When a takeover command is received from the server 2 during autonomous driving, the first controller 172 may identify the route information received from the server 2, store the identified route information, and control autonomous driving based on the stored waypoint information.

The first controller 172 may receive the waypoint information, the authentication number, the identification information of the second vehicle, and the identification information of the trailer of the second vehicle together when receiving the route information from the server 2, and store the received authentication number, identification information of the second vehicle, and identification information of the trailer of the second vehicle together.

The waypoint information may be information on a location where the second vehicle meets to take over the trailer.

The first controller 172 determines whether current information is a waypoint based on the current location information and the waypoint information during autonomous driving control based on the received route information, and when it is determined that the current information is a waypoint, the first controller 172 determines whether it arrives earlier than the second vehicle to take over the trailer based on the image information acquired by the image acquisition device.

When it is determined that the second vehicle has arrived first, the first controller 172 determines whether to approach the second vehicle based on the image information acquired by the rear camera 113, acquires the identification information of the second vehicle based on the image information acquired by the rear camera, and determines whether the acquired identification information of the second vehicle matches the stored identification information of the second vehicle.

When it is determined that the second vehicle has arrived first, the first controller 172 acquires the identification information of the second vehicle based on the image information acquired by the front camera 111 and determines whether the acquired identification information of the second vehicle matches the stored identification information of the second vehicle.

In addition, regardless of whether the second vehicle arrives at the line, the first controller 172 may determine whether the second vehicle approaches from the rear, and may acquire identification information of the second vehicle based on the image information acquired by the rear camera when it is determined that the second vehicle approaches from the rear, and also determine whether the acquired identification information of the second vehicle matches the stored identification information of the second vehicle.

When it is determined that the second vehicle approaches from the front, the first controller 172 may acquire the identification information of the trailer provided in the second vehicle based on the image information acquired by the front camera 111, and may also determine whether the acquired identification information of the trailer of the second vehicle matches the stored identification information of the trailer of the second vehicle.

When it is determined that the current information is a waypoint, the first controller 172 may control to perform communication with another vehicle existing in the vicinity, and may also determine whether the second vehicle has arrived at the waypoint through communication with other vehicles.

When it is determined that the second vehicle has approached, the first controller 172 may control communication with the second vehicle, transmit an authentication number to the second vehicle, and transmit current location information to the server 2.

The first controller 172 may determine that the second vehicle to take over the trailer exists within a predetermined distance when the same authentication number as the stored authentication number is received.

The predetermined distance may be a distance at which the first vehicle and the second vehicle may communicate.

The first controller 172 may also transmit waypoint arrival notification information to the server.

The first controller 172 may receive current location information of the second vehicle while communicating with the second vehicle, recognize current location information of the first vehicle, acquire distance information on the distance to the second vehicle based on the received current location information of the second vehicle and the recognized current location information of the first vehicle, and transmit the acquired distance information to the server 2.

The first controller 172 may perform communication between vehicles in a wireless communication method through the first communication device, use various wireless communication methods such as 3G, 4G, 5G, LTE, and the like, and acquire distance information about the distance between two vehicles through a wireless communication method, terrain around the vehicle, change in signal strength, and the like.

When the tractor and trailer are detached or coupled in hardware, the first controller 172 may control to generate a specific signal, encrypt this signal, and then control it to be transmitted to the server 2 in a wireless communication method. In this case, the server may decode and determine whether to detach or combine normally based on the corresponding signal.

The first controller 172 may receive distance information with the second vehicle 1b from the server 2, determine whether the distance difference value by the two distance information is less than or equal to a reference value by comparing the received distance information with the acquired distance information, and when the first controller 172 determines that the distance difference value is less than or equal to the reference value, may also determine whether the second vehicle 1b is a vehicle to take over the trailer based on whether at least one of whether the authentication number matches, whether the identification number of the vehicle matches, or whether the identification number of the trailer matches.

The first controller may receive the authentication number from the second vehicle 1b, and also determine whether the second vehicle 1b is a vehicle to take over the trailer by comparing the received authentication number with the stored authentication number.

When the received authentication number and the stored authentication number match, the distance difference value is less than the reference value, and the stored identification information of the second vehicle and the acquired identification number of the second vehicle match, the first controller 172 may determine that the second vehicle is a vehicle that will take over the trailer.

When the received authentication number and the stored authentication number match, the distance difference value is less than the standard value, and the stored identification information of the trailer of the second vehicle matches the identification number of the trailer of the second vehicle, the first controller 172 may determine that the second vehicle is a vehicle that will take over the trailer.

When it is determined that the second vehicle is the vehicle that will take over the trailer, the first controller 172 may control a coupling portion so that the trailer is automatically detached from the tractor.

The first controller 172 may also receive information on whether the authentication number matches from the server.

When the trailer is successfully detached, the first controller 172 may control autonomous driving to a changed destination based on the changed route information.

The first controller 172 may delete the stored authentication number when the trailer is successfully detached.

In the above, the configuration of the controller of the first vehicle that hands off the trailer to another vehicle has been described.

Hereinafter, the additional configuration of the controller of the second vehicle that takes over the trailer will be described.

The first controller 172 of the second vehicle controls autonomous driving to a waypoint based on the waypoint information when a trailer takeover command is received and waypoint information is received during autonomous driving control, determines whether current information is a waypoint based on current location information and waypoint information during autonomous driving control, and when it is determined that the current information is a waypoint, determines whether the second vehicle arrives at the waypoint earlier than the first vehicle based on image information acquired by the image acquisition device.

In response to determining that the second vehicle has arrived earlier than the first vehicle, the first controller 172 of the second vehicle determines whether or not the first vehicle approaches based on the image information acquired by the rear camera 113, acquires the identification information of the first vehicle based on the image information acquired by the rear camera 113, and determines whether the acquired identification information of the first vehicle matches the stored identification information of the first vehicle.

In response to determining that the first vehicle has arrived at the waypoint first, the first controller 172 of the second vehicle acquires the identification information of the first vehicle based on the image information acquired by the front camera 111, and determines whether the acquired identification information of the first vehicle matches the stored identification information of the first vehicle.

In addition, regardless of whether the second vehicle arrives after the first vehicle, the first controller 172 of the second vehicle may determine whether the first vehicle approaches from the rear, and may acquire identification information of the first vehicle based on the image information acquired by the rear camera when it is determined that the first vehicle approaches from the rear, and may also determine whether the acquired identification information of the first vehicle matches the stored identification information of the first vehicle.

In response to determining that the first vehicle approached from the front, the first controller 172 of the second vehicle may acquire the identification information of the trailer provided in the first vehicle based on the image information acquired by the front camera 111, and may also determine whether the acquired identification information of the trailer of the first vehicle matches the stored identification information of the trailer of the first vehicle.

In response to determining that the first vehicle has approached, the first controller 172 of the second vehicle may control communication with the first vehicle, transmit an authentication number to the first vehicle, and transmit current location information to the server 2.

The first controller 172 of the second vehicle may recognize the current location information of the second vehicle, receive the current location information of the first vehicle, acquire distance information on the distance to the first vehicle based on the received current location information of the first vehicle and the recognized current location information of the second vehicle, and transmit the acquired distance information to the server 2.

The first controller 172 of the second vehicle may receive distance information from the server to the first vehicle. In this case, the first controller 172 of the second vehicle may also acquire a distance difference value from the first vehicle by comparing the acquired distance information with the received distance information.

When it is determined that the trailer detached from the first vehicle is the trailer to be taken over, the first controller 172 of the second vehicle may control the coupling of the trailer detached from the first vehicle.

The first controller 172 of the second vehicle may control the coupling portion so that the trailer is automatically connected to the tractor.

Alternatively, the first controller 172 of the second vehicle may control the coupling portion so that the trailer is automatically connected to another trailer already connected.

The first controller 172 of the second vehicle may determine whether the trailer is successfully coupled, and when it is determined that the trailer is successfully coupled, may control autonomous driving to the destination based on route information.

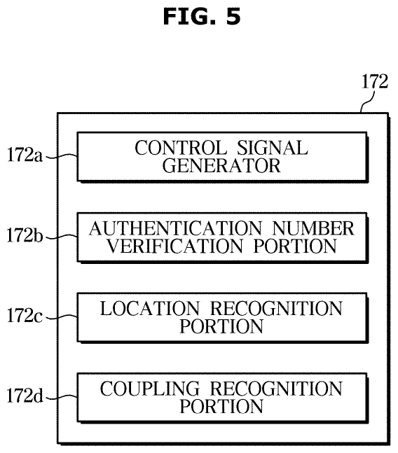

As shown in FIG. 5, the first controller may be implemented as a CPU (or DSP, MPU, etc.), an application specific integrated circuit (ASIC), a SoC, a micro computer (MICOM), or the like.

The first controller 172 may include a control signal generator 172a configured to generate a control signal for autonomous driving and a control signal for takeover of a trailer, an authentication number verification portion 172b configured to compare the stored authentication number with the authentication number transmitted from the second vehicle and identify whether they match when the second vehicle is recognized, a location recognition portion 172c configured to recognize current information of the first vehicle, and a coupling recognition portion 172d configured to recognize whether trailers are coupled, and to transmit a coupled signal for the coupling of trailers and a detach signal for separation of trailers to the server.

The first controller 172 may be a controller provided in the vehicle.

The first controller 172 may be implemented by an algorithm for controlling the operation of components in the vehicle, or a memory (not shown) for storing data about the program that reproduces the algorithm, and a processor (not shown) that performs the above-described operation using data stored in a memory.

In this case, the memory and the processor may be implemented as separate chips. Alternatively, the memory and the processor may be implemented as a single chip.

The first storage 173 may store map information.

The first storage 173 may store the authentication number, identification information of the second vehicle, and identification information of the trailer of the second vehicle.

In the case of the vehicle to which the trailer is to be taken over, the first storage 173 may store an authentication number, identification information of the first vehicle, and identification information of the trailer of the first vehicle.

The first storage 173 may store a program for performing the autonomous driving mode and may store a program for performing the navigation mode.

The first storage 173 may store destination information, store waypoint information, and store route information.

The first storage 173 may be a memory implemented as a chip separate from the processor described above with respect to the first controller 172, or may be implemented as a single chip with the processor.

The first storage 173 may be implemented as at least one of a storage medium such as a nonvolatile memory device such as a cache, a read only memory (ROM), a programmable ROM (PROM), an erasable programmable ROM (EPROM), an electrically erasable programmable ROM (EEPROM), and a flash memory, or a volatile memory device such as random access memory (RAM), or a storage medium such as a hard disk drive (HDD) and a CD-ROM, but is not limited thereto. The storage may be a memory implemented as a chip separate from the processor described above with respect to the controller, or may be implemented as a single chip with the processor.

The vehicle 1 includes an electronic control unit (ECU) 180 for controlling driving of a driving device, various safety devices, and various detection devices.

Here, the ECU 180 may be provided for each device or may be provided as one to control a plurality of electronic devices in an integrated manner.

The driving device 185 may be a device for applying driving force and braking force to front, rear, left, and right wheels, such as a power generating device, a power transmitting device, a driving device, a steering device, a braking device, a suspension device, a transmission device, a fuel device, and the like.

A coupling member 190 may be provided between the tractor and the trailer, so that the trailer is automatically coupled from the tractor, and the trailer is automatically detached from the tractor.

In addition, the tractor and trailer may be combined or detached by an external coupling device.

Each component illustrated in FIGS. 4 and 5 means software and/or hardware components such as field programmable gate array (FPGA) and application specific integrated circuit (ASIC).

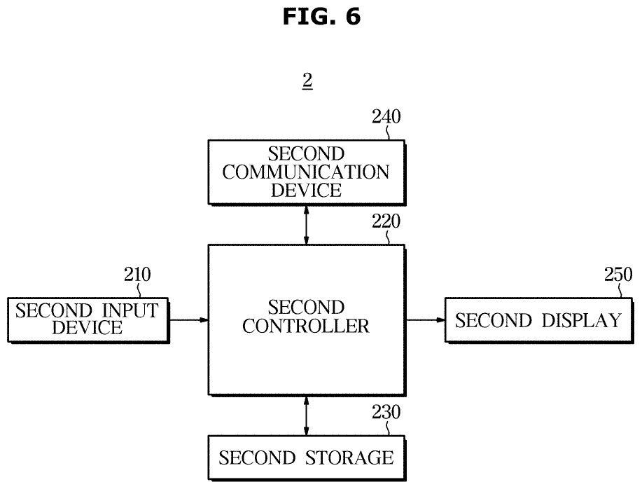

FIG. 6 is a control configuration diagram of a server communicating with a vehicle according to an embodiment.

The server 2 includes a second input device 210, a second controller 220, a second storage 230, a second communication device 240, and a second display 250.

The second input device 210 may receive identification information of a vehicle, identification information of a trailer provided in the vehicle, destination information, a destination change command, and a takeover command.

The second input device 210 may receive a selection command for any one of a plurality of route information.

The second controller 220 establishes a transportation plan based on destination information corresponding to the goods delivery point and location information of a plurality of vehicles.

The second controller 220 may transmit transportation information about the transportation plan to the vehicle.

The second controller 220 may determine whether the takeover of the trailer is efficient when it is determined that the goods delivery point has been changed, may acquire a second vehicle and a waypoint to take over the trailer when it is determined that the takeover of the trailer is efficient, and may transmit information on the waypoint and a takeover command to the acquired second vehicle.

The second controller 220 may acquire fuel efficiency information and delivery time information when moving from current information to a destination when transporting goods using the first vehicle, acquire fuel efficiency information and delivery time information when transporting goods using the second vehicle, and determine whether the takeover of the trailer is efficient based on the acquired information.

The second controller 220 may generate an authentication number and transmit the generated authentication number to the first and second vehicles when it is determined that the takeover of the trailer is efficient.

The second controller 220 may prevent the same authentication number from being effectively generated and used in the same time period by linking information such as the current time at the moment when the authentication number generation control signal is input to the authentication number generation.

The second controller 220 may compare the original data (authentication number) by decrypting the one-time random authentication number to which various security algorithms such as encryption are applied using a decryption method predefined by the user.

After determining that the use of the one-time random authentication number is terminated, the second controller 220 may delete the corresponding authentication number.

When location information is received from the first and second vehicles, the second controller 220 may acquire distance information on the distance between the first vehicle and the second vehicle based on the location information from the first and second vehicles, and transmit the acquired distance information to the first and second vehicles.

The acquired distance information may be distance information acquired based on GPS location information of the first and second vehicles.

When distance information is received from the first vehicle or the second vehicle, the second controller 220 may compare the received distance information with the acquired distance information, and determine whether a distance difference value between the received distance information and the acquired distance information is less than or equal to a reference value.

The received distance information may be distance information acquired by a communication signal through communication of the first and second vehicles.

The second controller 220 may determine whether to take over the trailer of the first vehicle based on at least one of minimizing the total cost of ownership (TOC), minimizing the total delivery time, and minimizing the initial delivery cost when transporting trailers using the first vehicle and the second vehicle. Here, the second vehicle may be a vehicle traveling within a preset distance from the first vehicle.

More specifically, the second controller 220 may determine whether to take over the trailer of the first vehicle based on a distance between the changed destination and the first vehicle when the destination of the first vehicle is changed, a distance between the changed destination and the second vehicle, a fuel amount of the first vehicle, a fuel amount of the second vehicle, route information of the first vehicle, route information of the second vehicle, an existence of the trailer of the second vehicle, the number of trailers of the second vehicle, a weight of the trailer of the first vehicle, a weight of the article of the first vehicle, a weight of the trailer of the second vehicle, and a weight of the article of the second vehicle.

When it is determined that trailer transport is maintained, the second controller may acquire route information to the changed destination and transmit the acquired route information to the first vehicle.

When it is determined that the trailer is taken over, the second controller 220 may select the takeover information for the second vehicle and the first vehicle to meet and take over the trailer based on the current location information of the first vehicle, the changed destination information, and the current location information of the second vehicle, and transmit waypoint information for the selected takeover information to the first and second vehicles.

More specifically, when it is determined that the trailer is taken over, the second controller 220 may select takeover information based on the size of the first vehicle (full width, full length, full height), the size of the second vehicle (full width, full length, full height), the size of the trailer connected to the first vehicle (full width, full length, full height), the size of the trailer connected to the second vehicle (when more than one trailer is already connected, the full width, overall length, and total height), the remaining fuel amount of the first vehicle, the remaining fuel amount of the second vehicle, the moving path of the first vehicle, the moving path of the second vehicle, and map information.

When it is determined that the trailer is taken over, the second controller 220 may generate an authentication number, store the generated authentication number, and transmit the generated authentication number to the first and second vehicles.

When it is determined that the trailer is taken over, the second controller 220 may transmit the identification information of the first vehicle and the identification information of the trailer of the first vehicle to the second vehicle, and transmit the identification information of the second vehicle and the identification information of the trailer of the second vehicle to the first vehicle.

The second controller 220 may periodically receive the location information of the first and second vehicles, determine whether the first and second vehicles are adjacent to each other based on the received location information of the first and second vehicles, and transmit adjacency information to the first and second vehicles when it is determined that the first and second vehicles are adjacent to each other.

The second controller 220 may receive the identification information of the second vehicle recognized from the first vehicle or the identification information of the trailer of the second vehicle from the first vehicle, and receive the identification information of the first vehicle recognized by the second vehicle or the identification information of the trailer of the first vehicle from the second vehicle.

Here, the identification information of the first and second vehicles may be vehicle numbers of the first and second vehicles.

The second controller 220 may determine whether the first and second vehicles are vehicles to take over the trailer based on the received identification information of the first and second vehicles, the identification information of the trailer, the identification information of the trailer stored in the second storage, and the identification information of the vehicle.

The second controller 220 may determine whether the separation of the trailer of the first vehicle is successful based on the separation signal transmitted from the first vehicle, and determine whether the coupling of the trailer of the second vehicle is successful based on the combined signal transmitted from the second vehicle.

When it is determined that the takeover of the trailer is completed, the second controller 220 may update the identification information of the trailer and the identification information of the vehicle corresponding to the takeover of the trailer.

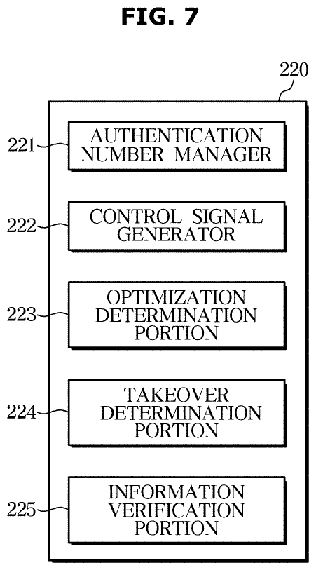

As shown in FIG. 7, the second controller 220 may also include an authentication number manager 221 configured to generate an authentication number to be transmitted to the first and second vehicles that take over the trailer, manage the generated authentication number, and delete the stored authentication number in response to the takeover result of the trailer, a control signal generator 222 configured to design a transportation plan using the first and second vehicles, transmit information about the designed transportation plan to the first and second vehicles, and generate various control signals for the trailer takeover command in response to a change in destination, an optimization determination portion 223 configured to determine the efficiency of the takeover of the trailer, and determine the optimized vehicle and optimized takeover information, a takeover determination portion 224 configured to determine the takeover of trailers between the first and second vehicles, and an information verification portion 225 configured to verify information between the first and second vehicles, and verify distance information between the first and second vehicles.

The second storage 230 may store autonomous driving information for transporting trailers and may store transport information for each vehicle.

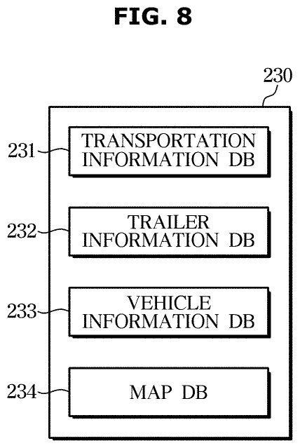

As shown in FIG. 8, the second storage 230 may include a transportation information database 231 for storing transportation information for transportation plans, a trailer information database 232 for storing identification information of a trailer corresponding to identification information of a vehicle, a vehicle information database 233 for storing identification information, and a map database 234.

The second communication device 240 may communicate with one or more vehicles 1.

The second communication device 240 may receive location information of a plurality of vehicles.

The second communication device 240 may transmit route information, destination information, a destination change command, and a takeover command in response to the control command of the second controller 220.

The second communication device 240 may transmit identification information of a vehicle to take over the trailer, identification information of the trailer, and an authentication number in response to the control command of the second controller 220.

The second communication device 240 may transmit waypoint information, changed destination information, and changed route information in response to the control command of the second controller 220.

The second display 250 may display plan information for the goods transport plan as an image.

The second display 250 may display identification information of a vehicle, identification information of a trailer provided in the vehicle, destination information, and identification information of a vehicle to be handed over as images.

The second display 250 may display the waypoint information, the changed destination information, and the changed route information as an image in response to the control command of the second controller 220.

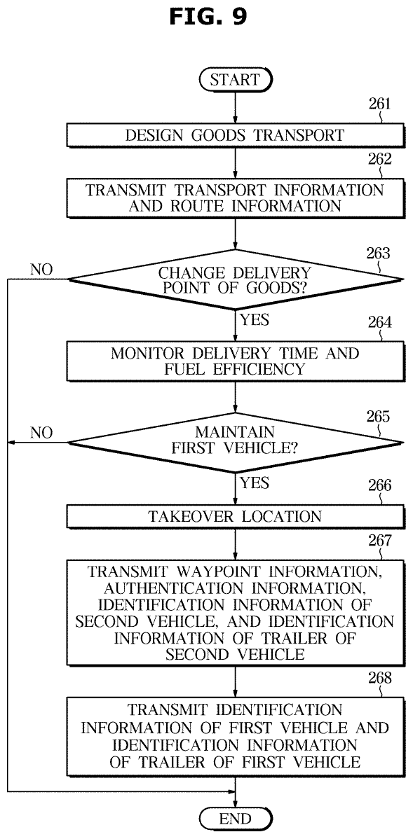

FIG. 9 is a control flowchart of a server performing communication with a vehicle according to an embodiment.

The server 2 designs a goods transport plan based on destination information corresponding to the goods delivery point and location information of a plurality of vehicles (261).

The server 2 transmits transport information for a transport plan and route information for transporting goods to the vehicle (262).

When it is determined that the delivery point of the goods is changed during the transport of goods using the first vehicle (YES at 263), the server 2 determines whether to maintain the vehicle for transporting the trailer loaded with the goods as the first vehicle.

The server monitors the delivery time by the first vehicle and the fuel efficiency of the first vehicle, the delivery time by the second vehicle and the fuel efficiency of the second vehicle (264), and determines whether it is efficient to takeover the trailer by another vehicle based on the monitoring result.

When it is determined that the takeover of the trailer is efficient, the server searches for the second vehicle to take over the trailer.

Here, the second vehicle may be a vehicle located adjacent to the first vehicle, and may be a vehicle that travels to the same destination as the delivery point or travels to a destination adjacent to the delivery point.

More specifically, the server determines whether to takeover the trailer of the first vehicle by the second vehicle based on, when the delivery point of the goods is changed, the distance between the changed delivery point (that is, the changed destination) and the first vehicle, the distance between the changed destination and the second vehicle, the fuel amount of the first vehicle, the fuel amount of the second vehicle, the route information of the first vehicle, the route information of the second vehicle, the existence of the second vehicle trailer, the number of trailers of the second vehicle, the trailer weight of the first vehicle, the weight of the first vehicle article, the second vehicle trailer weight, and the second vehicle weight.

In addition, the server may acquire delivery times by the first and second vehicles based on the distance between the changed delivery point (that is, the changed destination) and the first vehicle, and the distance between the changed destination and the second vehicle.

The server may acquire the fuel efficiency of the first and second vehicles based on the distance between the changed delivery point (that is, the changed destination) and the first vehicle, the changed destination and the second vehicle, the fuel amount of the first vehicle, the fuel amount of the second vehicle, the route information of the first vehicle, the route information of the second vehicle, the existence of the trailer of the second vehicle, the number of trailers of the second vehicle, the weight of the trailer of the first vehicle, the weight of the goods of the first vehicle, the weight of the trailer of the second vehicle, and the weight of the goods of the second vehicle.

When it is determined that the determination result is to maintain transportation to the first vehicle (265) and it is determined that it is efficient to maintain transportation to the first vehicle, the server may search a route for the changed delivery point in the first vehicle, and transmit route information on the discovered route and destination information on the changed delivery point to the first vehicle.

When it is determined that the trailer is to be taken over by the second vehicle, the server 2 may search for the second vehicle with the takeover information for the trailer, select the optimal takeover information among the searched takeover information (266), and transmit the waypoint information for the selected takeover information to the first and second vehicles.

When selecting takeover information, the server may select takeover information based on the size of the first vehicle (full width, full length, full height), the size of the second vehicle (full width, full length, full height), the size of the trailer connected to the first vehicle (full width, full length, full height), the size of the trailer connected to the second vehicle (when more than one trailer is already connected, the full width, overall length, and total height), the remaining fuel amount of the first vehicle, the remaining fuel amount of the second vehicle, the moving path of the first vehicle, the moving path of the second vehicle, and map information.

When it is determined that the takeover of the trailer is efficient, the server 2 may generate an authentication number and transmit the generated authentication number to the first and second vehicles. When generating the authentication number, the server may prevent the same authentication number from being effectively generated and used in the same time zone by linking the time information at the time of authentication number generation with the authentication number generation.

The server 2 may generate a route to the waypoint based on the current location information and the waypoint information of the first vehicle, and transmit route information on the created route to the first vehicle.

The server 2 may generate a route to the waypoint based on the current location information and the waypoint information of the second vehicle, and transmit route information on the created route to the second vehicle.

When transmitting waypoint information to the first vehicle, the server 2 transmits the trailer takeover command, route information, authentication number, identification information of the second vehicle, and the identification information of the trailer of the second vehicle to the first vehicle (267).

When transmitting the waypoint information to the second vehicle, the server transmits a trailer takeover command, route information, authentication number, identification information of the first vehicle, and trailer identification information of the first vehicle to the second vehicle (268).

When location information is received from the first and second vehicles while the first and second vehicles are autonomously driving as a waypoint, the server may obtain distance information on the distance between the first vehicle and the second vehicle based on the location information from the first and second vehicles, and transmit the acquired distance information to the first and second vehicles.

The distance information acquired here may be distance information acquired based on the GPS location information of the first and second vehicles.

The server may transmit adjacency information to the first and second vehicles when the distance between the first and second vehicles is less than a predetermined distance based on the acquired distance information.

The server may receive the authentication number from the first and second vehicles, and also transmit information about whether the received authentication number matches the stored authentication number to the first and second vehicles.

The server may compare the received distance information and the acquired distance information when the distance information is received from the first vehicle or the second vehicle, may determine whether the distance difference value between the received distance information and the acquired distance information is less than or equal to a reference value, and may transmit adjacency information to the first and second vehicles when it is determined that the distance difference value is less than or equal to the reference value.

The server may determine whether the separation of the trailer of the first vehicle is successful based on the separation signal transmitted from the first vehicle, and determine whether the coupling of the trailer of the second vehicle is successful based on the combined signal transmitted from the second vehicle.

When it is determined that the takeover of the trailer is completed based on the success of the separation of the trailer of the first vehicle and the success of the coupling of the trailer of the second vehicle, the server may delete the one-time random authentication number after determining that the use of the authentication number is over.

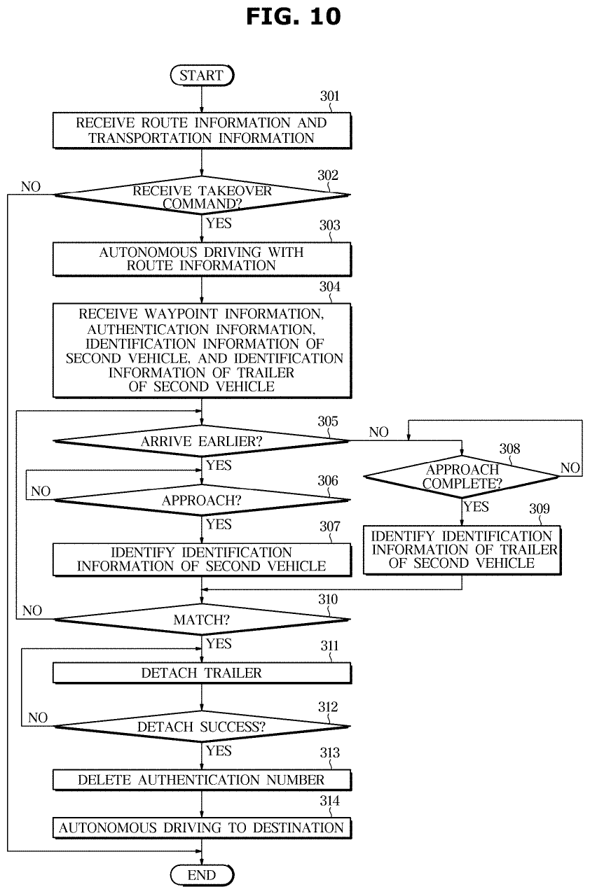

FIG. 10 is a control flowchart of a vehicle according to an embodiment.

The first vehicle may receive route information and transport information from the server 2 to the destination (301), and may control autonomous driving in response to a departure command.

When a takeover command is received from the server 2 during autonomous driving (YES to 302), the first vehicle identifies the changed route information and autonomously drives to a waypoint based on the identified route information (303).

Here, the takeover command is generated from the server in response to a change in the delivery point of the goods, and may be a command to take over the trailer to the second vehicle.

The waypoint may be a location for taking over the trailer to the second vehicle.

The first vehicle may receive the waypoint information, the authentication number, the identification information of the second vehicle, and the identification information of the trailer of the second vehicle when receiving the changed route information (304), and store the received waypoint information, authentication number, identification information of the second vehicle, and identification information of the trailer of the second vehicle.

The vehicle determines whether the current information is a waypoint based on the current location information and the waypoint information, and when it is determined that the current information is a waypoint, determines whether the vehicle arrives earlier than the second vehicle (305).

In addition, the first vehicle may transmit location information to the server during autonomous driving, and at this time, may also receive information on whether or not to arrive in advance from the server.

The first vehicle may determine whether it arrives earlier than the second vehicle based on image information acquired by the image acquisition device.

When it is determined that the first vehicle arrives earlier than the second vehicle (YES at 305), the first vehicle determines whether to approach the second vehicle based on the image information acquired by the rear camera 113 (306), and when it is determined that the first vehicle approaches the second vehicle (YES at 306)), the identification information of the second vehicle is identified based on the image information acquired by the rear camera (307).

The first vehicle, when it is determined that the second vehicle has arrived first (NO at 305), determines whether the approach to the second vehicle has been completed (308), and when it is determined that the approach to the second vehicle is complete (YES at 308), identifies the identification information of the second vehicle or the identification information of the trailer of the second vehicle based on the image information acquired by the front camera 111 (309), and determines whether the identified identification information of the second vehicle matches the stored identification information of the second vehicle (310).

When the trailer is already connected to the second vehicle, the first vehicle may identify the identification information of the trailer of the second vehicle.

When the trailer is not connected to the second vehicle, the first vehicle may identify the identification information of the second vehicle.

The first vehicle, when it is determined that it is adjacent to the second vehicle, may attempt a communication connection with the second vehicle, and may acquire distance information about the distance to the second vehicle based on the received signal strength during communication with the second vehicle when communication with the second vehicle is connected, and may transmit the acquired distance information to the server 2.

The first vehicle may transmit the stored authentication number to the server and the second vehicle.

When it is determined that the stored identification information of the second vehicle and the identified identification information of the second vehicle match (YES to 310), the first vehicle automatically detaches the trailer (311).

In addition, when the stored identification information of the second vehicle and the confirmed identification information of the second vehicle match, the stored authentication number and the received authentication number match, and adjacency information is received from the server that the distance difference value is less than or equal to the reference value, the first vehicle may automatically detach the trailer.

When it is determined that the separation of the trailer is successful (YES to 312), the first vehicle may transmit a signal for the successful separation to the server and delete the authentication number (313).

The second vehicle receives route information based on waypoint information and destination information, and autonomously drives to a destination based on the received route information (314).

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored, for example, a Read Only Memory (ROM), a Random Access Memory (RAM), a magnetic tape, a magnetic disk, a flash memory, an optical data storage device, and the like.

Embodiments of the present disclosure can respond to a goods delivery request of a customer within the shortest time by taking over the trailer to another vehicle without intervention of the driver when the destination is changed according to the change of the goods delivery point during autonomous driving leaving the departure point. Embodiments of the present disclosure can deliver the maximum amount of goods with a limited number of vehicles. Embodiments of the present disclosure can reduce fuel consumption of the vehicle and thereby improve fuel efficiency.

According to embodiments of the present disclosure, fuel efficiency improvement and delivery time can be easily recognized by providing route information to a destination, fuel efficiency change information according to trailer takeover for each section in the route, and arrival time information of the destination.

As such, embodiments of the present disclosure can improve the quality and marketability of an autonomous driving control apparatus and vehicle having an autonomous driving function, further enhance user satisfaction, and secure product competitiveness.

Although exemplary embodiments of the present disclosure have been described for illustrative purposes, those skilled in the art will appreciate that various modifications, additions and substitutions are possible, without departing from the scope and spirit of the disclosure. Therefore, exemplary embodiments of the present disclosure have not been described for limiting purposes.

What is claimed is:

1. A server comprising:
a communication device configured to communicate with a plurality of vehicles; and
a controller configured to:
receive location information of the plurality of vehicles;
generate route information based on the received location information of the plurality of vehicles and goods transport information;
transmit the generated route information to a first vehicle among the plurality of vehicles;
select a second vehicle among the plurality of vehicles and a takeover location to take over goods based on delivery point information including a delivery point and location information of the plurality of vehicles when the delivery point information among the goods transport information is changed during traveling of the first vehicle;
generate route information of the first and the second vehicles based on waypoint information for the takeover location; and
transmit the generated route information of the first and the second vehicles to the first and the second vehicles, respectively.

2. The server according to claim 1, wherein the controller is configured to generate an authentication number and transmit the generated authentication number to the first and the second vehicles.

3. The server according to claim 1, wherein, in response to the location information of the first vehicle and the location information of the second vehicle being received, the controller is configured to:
acquire distance information on a distance between the first and the second vehicles based on the received location information of the first vehicle and the received location information of the second vehicle;
determine whether the first and the second vehicles are adjacent to each other based on the acquired distance information; and
transmit adjacency information of the first and the second vehicles to the first and the second vehicles.

4. The server according to claim 1, wherein the controller is configured to select the takeover location based on a full width, a full length and a total height of a trailer provided with the first vehicle, and a full width, a full length and a total height of a trailer provided with the second vehicle.

5. The server according to claim 1, wherein the controller is configured to determine whether to take over the goods based on a fuel amount of the first vehicle, a weight of the goods, a distance between the first vehicle and the delivery point, and a distance between the second vehicle and the delivery point.

6. The server according to claim 1, wherein the controller is configured to transmit identification information of the second vehicle to the first vehicle and transmit identification information of the first vehicle to the second vehicle.

7. The server according to claim 1, wherein, in response to the location information of the first vehicle and the location information of the second vehicle being received, the controller is configured to:
acquire distance information on a distance between the first and the second vehicles based on the received location information of the first vehicle and the received location information of the second vehicle; and
transmit the acquired distance information to the first and the second vehicles.

8. A vehicle comprising:
a tractor;
a trailer detachably coupled to the tractor and configured to be loaded with goods;
a coupling member configured to couple and detach the trailer;
a communication device configured to communicate with a server and a second vehicle and receive location information; and
a controller configured to:
in response to first route information being received from the server, control autonomous driving based on the received first route information;
in response to a takeover command, waypoint information and second route information being received from the server, control autonomous driving based on the received second route information; and
control an operation of the coupling member to detach the trailer based on the received location information and the received waypoint information.

9. The vehicle according to claim 8, wherein the controller is configured to transmit a separation signal of the trailer to the server in response to a determination that a separation of the trailer is successful.

10. The vehicle according to claim 9, wherein the controller is configured to:
receive and store an authentication number from the server;
attempt a communication connection with the second vehicle in response to a determination that current information is a waypoint based on the received location information and the received waypoint information;
receive an authentication number of the second vehicle in response to communication with the second vehicle being connected; and
determine whether the second vehicle is a vehicle to take over the trailer based on whether the stored authentication number and the received authentication number match.

11. The vehicle according to claim 10, wherein the controller is configured to delete the stored authentication number in response to the determination that the separation of the trailer is successful.

12. The vehicle according to claim 10, wherein the controller is configured to acquire distance information on a distance to the second vehicle in response to communication with the second vehicle being connected.

13. The vehicle according to claim 8, further comprising an image acquisition device, wherein the controller is configured to:
store identification information of the second vehicle received from the server;
acquire identification information of the second vehicle based on image information acquired by the image acquisition device; and
determine whether the second vehicle is a vehicle to take over the trailer based on whether the acquired identification information of the second vehicle matches the stored identification information of the second vehicle.

14. The vehicle according to claim 8, wherein the controller is configured to:
receive and store an authentication number from the server;
attempt a communication connection with the second vehicle in response to a determination that current information is a waypoint based on the received location information and the received waypoint information;
transmit an authentication number of the second vehicle in response to communication with the second vehicle being connected; and
control the operation of the coupling member so that the trailer is detached in response to matching information of the authentication number being received from the second vehicle.

15. A vehicle comprising:
a tractor;
a coupling member configured to couple and uncouple the tractor and a trailer;
a communication device configured to communicate with a server and other vehicles and receive location information of the other vehicles; and
a controller configured to:
receive a takeover command, waypoint information, and route information from the server;
in response to receiving the takeover command, the waypoint information, and the route information, control autonomous driving based on the received route information; and
control an operation of the coupling member so that the trailer is coupled to the tractor based on the received location information and the received waypoint information.

16. The vehicle according to claim 15, wherein the controller is configured to transmit a separation signal of the trailer to the server in response to a determination that the coupling of the trailer is successful.

17. The vehicle according to claim 15, wherein the controller is configured to:
receive and store an authentication number from the server;
attempt a communication connection with one of the other vehicles in response to determining that current information is a waypoint based on the received location information and the received waypoint information;
receive an authentication number of the one of the other vehicles in response to communication with the one of the other vehicles being connected; and
determine whether the one of the other vehicles is a vehicle to take over the trailer based on whether the stored authentication number and the received authentication number match.

18. The vehicle according to claim 17, wherein the controller is configured to delete the stored authentication number in response to a determination that the coupling of the trailer is successful.

19. The vehicle according to claim 15, wherein the controller is configured to:
acquire distance information about a distance to one of the other vehicles in response to a communication with the one of the other vehicles being connected;
transmit the acquired distance information to the server; and
control the operation of the coupling member so that the trailer is coupled to the one of the other vehicles in response to adjacency information being received from the server.

20. The vehicle according to claim 15, further comprising an image acquisition device configured to acquire image information, wherein the controller is configured to:
store identification information of one of the other vehicles received from the server;
acquire identification information of the one of the other vehicles based on the image information acquired by the image acquisition device; and
determine whether the one of the other vehicles is a vehicle to take over the trailer based on whether the acquired identification information of the one of the other vehicles matches the stored identification information of the one of the other vehicles.
